(19) United States
(12) Patent Application Publication
(10) Pub. No.: US 2013/0332546 A1
(43) Pub. Date: Dec. 12, 2013

(54) EMAIL PROCESSING SYSTEM AND EMAIL PROCESSING METHOD

(71) Applicant: SEIKO EPSON CORPORATION, Tokyo (JP)

(72) Inventor: Raigo MIYAZAWA, Matsumoto (JP)

(21) Appl. No.: 13/905,512

(22) Filed: May 30, 2013

(30) Foreign Application Priority Data
Jun. 11, 2012 (JP) 2012-131640

(51) Int. Cl. H04L 12/58

(52) U.S. Cl. CPC H04L 51/28
USPC 709/206

(57) ABSTRACT

To process data in a plurality of devices without waste, on the basis of a multi-address transmitted email in a cloud computing system for processing emails, an email processing system, provided with: a communication unit for receiving an email sent to a pre-established first address; a determination unit for determining whether or not the received email is a specific email where the transmission destination includes a second address other than the first address and where a response by email can be sent to the first address from the second address; and a processing unit for executing a predetermined data process based on an email determined not to be the specific email but not executing the predetermined data process based on an email determined to be the specific email.

### CROSS-REFERENCE TO RELATED APPLICATIONS

This application claims priority to Japanese Patent Application No. 2012-131640 filed on Jun. 11, 2012. The entire disclosure of Japanese Patent Application No. 2012-131640 is hereby incorporated herein by reference.

### BACKGROUND

1. Technical Field

The present invention relates to an email processing system and an email processing method; in particular, the invention relates to a cloud computing system for making it possible to send an email to a specific email address and thereby print a body or an attached file of the email.

2. Background Technology

A cloud computing system provided with a function for receiving an email and then printing the body or an attached file of the email has been known (for example, Patent Document 1). The cloud computing system (hereinafter simply a “print system”) is provided with a server for receiving a specific email and thereupon generating print data corresponding to a specific printer on the basis of a body or an attached file of the email, and a printer for acquiring the print data from the server and executing printing. As such, a user of the print system is enabled to use a printer that is registered in the print system even in a case where a printer driver has not been installed in a client terminal, such as a personal computer (PC) or smartphone. In the print system, when a process for registering a printer, including allocating to the printer an email address for receiving something that is to be printed, has been done in a server, then any user who knows the email address will be able to use the printer. Such a print system is similar to a facsimile in that sent information is printed at a destination.

Japanese Laid-open Patent Publication No. 2008-71257 (Patent Document 1) is an example of the related art.

### SUMMARY

### Problems to be Solved by the Invention

Some mail servers and so-called mail transfer agents (MTAs) are provided with a function for automatic reply or for automatic forwarding. It is then supposed herein that an email X distributed to a plurality of addresses, including in the destinations an email address B that has been allocated to a printer registered in the print system, is delivered to an email address A for which an automatic response function has been set to active so as to “reply to all”. In such a case, the print system described above would receive both the email X and an email Y automatically replied from the email address A. In such a case, should printing be then executed on the basis of the email Y, the printing executed would be unintended and wasteful. In view whereof, in the print system described above, consideration is given to processing as invalid an email for which a plurality of destinations have been set.

However, in the print system described above, it would be desirable to still be able to use a function similar to the multi-address transmission of a facsimile, by multi-address transmission of an email to email addresses respectively allocated to a plurality of registered printers.

One advantage of the invention is to process data in a plurality of devices without waste on the basis of a multi-address transmitted email, within a cloud computing system for processing emails.

### Means Used to Solve the Above-Mentioned Problems

An email processing system for achieving the foregoing advantage is provided with: a communication unit for receiving an email sent to a pre-established first address; a determination unit for determining whether or not the received email is a specific email where the transmission destination includes a second address other than the first address and where a response by email can be sent to the first address from the second address; and a processing unit for executing a predetermined data process based on an email determined not to be the specific email but not executing the predetermined data process based on an email determined to be the specific email. According to the invention, a predetermined data process is executed on the basis only of an email for which it is not possible for the email processing system to receive an email sent in reply to the same email as an email received by the email processing system. For this reason, wasteful execution of the data process for printing or the like based on an automatically replied email or the like can be prevented. In turn, even with an email that includes a plurality of transmission destinations, it is possible to send with a setting such that at one transmission destination the other transmission destinations cannot be recognized, and thus multi-address transmission of an email that undergoes execution of a predetermined data process in a plurality of systems is possible.

The functions of each of the parts set forth in the claims are implemented by the hardware resources for which the configuration itself identifies a function, by hardware resources for which a program identifies a function, or by a combination thereof. Also, the functions of each of the parts are not limited to each being implemented by one or a plurality of hardware resources that are physically independent of one another, but rather a plurality of functions may be implemented by one hardware resource. The invention is established also as a method, also as a computer program for causing a server and a printer to implement the functions described above, and also as a recording medium for the program. It shall be readily understood that the recording medium for the computer program may be a magnetic recording medium, a magneto-optical recording medium, or some recording medium that is developed in the future.

### BRIEF DESCRIPTION OF THE DRAWINGS

Referring now to the attached drawings which form a part of this original disclosure:

FIG. 1 is a block diagram illustrating a print system;

FIG. 2A is a block diagram illustrating a configuration of a server, and FIG. 2B is a block diagram illustrating a configuration of a printer;

FIG. 3 is a sequence diagram illustrating a setup sequence;

FIG. 4 is a sequence diagram illustrating a login sequence;

FIG. 5 is a sequence diagram illustrating a print sequence;

FIG. 6 is a flow chart illustrating a determination sequence; and

FIGS. 7A-7F are schematic diagrams illustrating a mode for distributing an email.

### DETAILED DESCRIPTION OF EXEMPLARY EMBODIMENTS

The following describes modes for carrying out the invention, with reference to the accompanying drawings. Constituent elements that correspond to each other in each of the drawings have been assigned like reference numerals, and duplicate descriptions thereof have been omitted.

### 1. Configuration

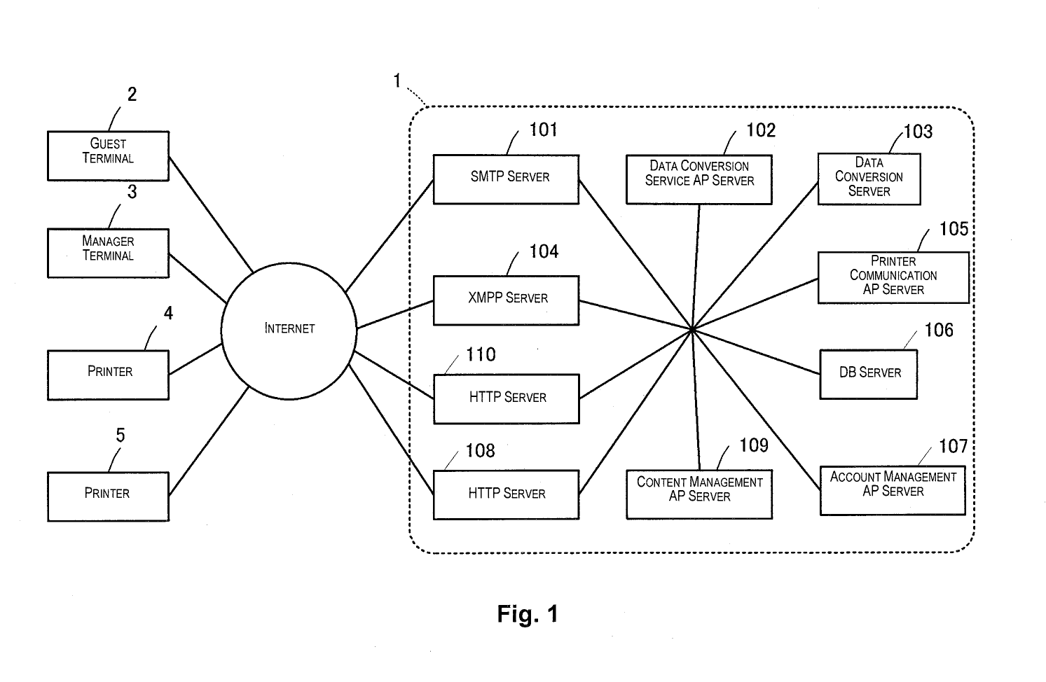

FIG. 1 is a block diagram illustrating a print system serving as one embodiment of the invention. The print system is configured to be a cloud computing system making it possible for an email to be sent to an email address associated with registered printers 4, 5 and for a body and an attachment file of the email to thereby be printed, and is constituted of an email processing system 1 and a plurality of printers 4, 5.

The email processing system 1 is constituted of a simple mail transfer protocol (SMTP) server 101, a data conversion service application (AP) server 102, a data conversion server 103, an extensible messaging and presence protocol (XMPP) server 104, a printer communication AP server 105, a database (DB) server 106, an account management AP server 107, a hypertext transfer protocol (HTTP) server 108, a content management AP server 107, and an HTTP server 110.

The SMTP server 101, which serves as a communication unit, is a server that has a function for sending and receiving an email at an email address allocated to the registered printers 4, 5.

The data conversion service AP server 102, which serves as a determination unit, is an application server that has a function for determining whether an email received by the SMTP server 101 is an email intended to be printed or is a specific email not intended to be printed, extracting a body and an attached file from an email intended to be printed, and delivering the attachment file and a text file of the body to the data conversion server 103 as being intended to be printed.

The data conversion server 103, which serves as a processing unit, is a server that has a function for converting to print data the file acquired as being intended to be printed from the data conversion AP server 102. The DB server 106 is a database server for managing a variety of forms of information on the printers 4, 5 and for storing print data.

The XMPP server 104 is a server that has a function for communicating with the printers 4, 5 by using XMPP. The printer communication AP server 105 is an application server for relaying between the XMPP server 104 and the other servers.

The account management AP server 107 is an application server for relaying between the HTTP server 110 and the other servers. The HTTP server 110 is a server that has a function for communicating with a guest terminal 2 and a manager terminal 3 by using HTTP.

The content management AP server 107 is an application server for relaying between the HTTP server 108 and other servers. The HTTP server 108 is a server that has a function for communicating with the printers 4, 5 by using HTTP.

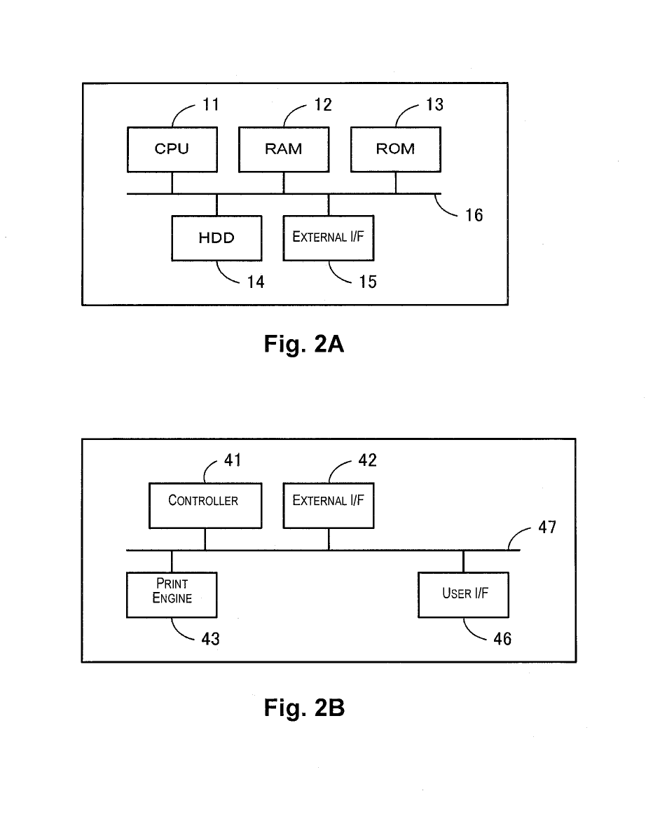

The SMTP server 101, the data conversion service AP server 102, the data conversion server 103, the XMPP server 104, the printer communication AP server 105, the DB server 106, the account management AP server 107, the HTTP server 108, the content management AP server 107, and the HTTP server 110 are each provided with a CPU 11, a RAM 12, a ROM 13, a hard disk device (HDD) 14, an external interface (I/F) 15, and an internal interface (I/F) 16 for connecting same together, as illustrated in FIG. 2A. The ROM 13 stores a startup program. The HDD 14 stores a computer program for implementing each of the various functions described above as well as an operating system (OS). These programs are loaded into the RAM 12 and executed by the CPU 11. The external I/F 15 is constituted of: an interface for connecting with the other servers, the printers 4, 5, the guest terminal 2, the manager terminal 3, and the like via the Internet; an interface for connecting to a peripheral device; and the like.

Each of the printers 4, 5 is provided with a controller 41, an external I/F 42, a user I/F 46, a print engine 43, and an internal I/F 47 for connecting same together, as illustrated in FIG. 2B. The controller 41 includes a CPU, non-volatile memory, RAM, ASIC, and the like, and executes a process for controlling the operation of the print engine 43 by executing a print program stored in the non-volatile memory. The controller 41 communicates with the manager terminal 3 and the email processing system 1 by executing a web service program stored in the non-volatile memory to execute a process for registering the printers 4, 5 in the email processing system 1 or for acquiring print data from the email processing system 1. The print engine 43 is provided with an actuator, a sensor, a drive circuit, and a mechanical component for executing printing in an inkjet format, a laser format, or another print format known in the art. The external I/F 42 includes an interface for connecting to the email processing system 1 or to the manager terminal 3 via the Internet. The user I/F 46 is an operation panel constituted of a display, operation keys, and the like.

### 2-1. Setup Sequence

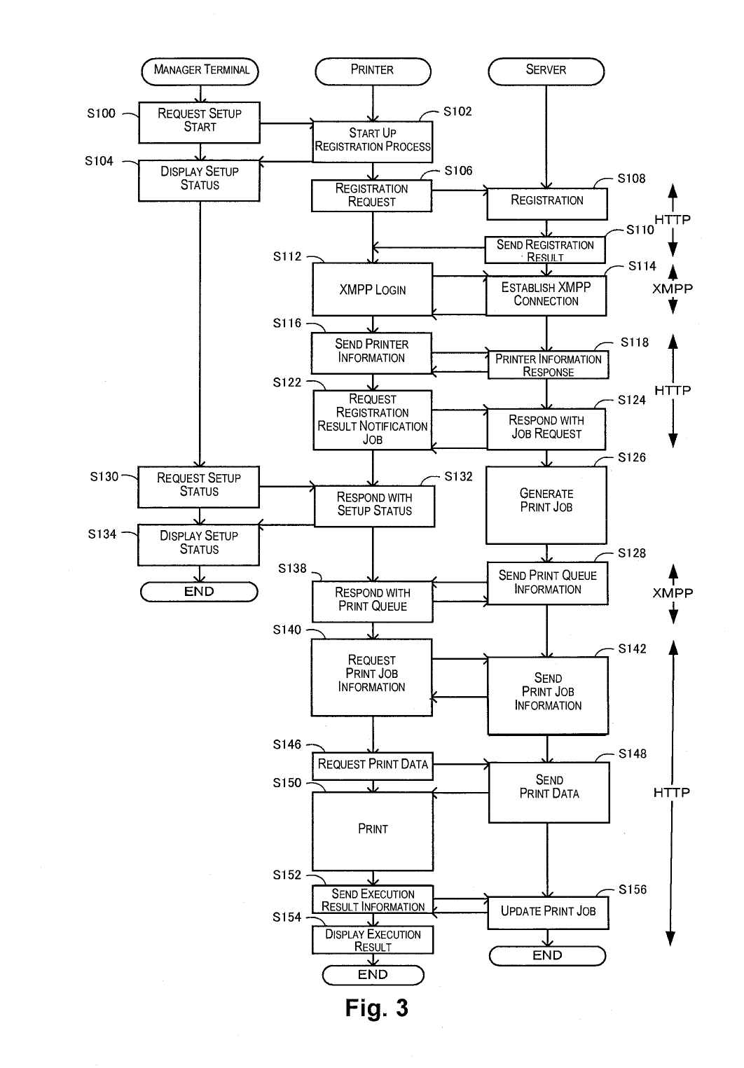

By being registered in the email processing system 1, the printers 4, 5 are incorporated into the print system, enabling the email processing system 1 to execute printing in accordance with an email deemed to be intended to be printed. FIG. 3 is a diagram illustrating a setup sequence for registering the printers 4, 5 in the email processing system 1. The present embodiment describes an example in which an owner of the printer 4 registers the printer 4 in the email processing system 1 by operating the manager terminal 3, which includes a person computer (PC) owned by him.

First, the manager terminal 3, which executes a web browser or the like, communicates with the printer 4 by using HTTP and thereby sends to the printer 4 a setup start request (S100).

Having acquired the setup start request, the printer 4 starts up a registration process, and sends registration status information to the manager terminal 3 by using HTTP (S102).

Having received the registration status information, the manager terminal 3 produces a screen display of the setup status on the basis of the received registration status information (S104).

Having sent the registration status information in accordance with the setup start request, the printer 4 uses HTTP to send to a URL of the HTTP server 108 corresponding to the registration request a model-specific ID of the printer 4, a serial number of the printer 4, and a delete flag for preexisting information, as a registration request corresponding to the printer 4 (S106).

Having acquired the registration request in the HTTP server 108, the email processing system 1 registers the printer 4 in the email processing system 1 as an output device of the print system, on the basis of the registration request (S108). More specifically, having acquired a parameter of the registration request from the HTTP server 108, the account management AP server 107 allocates to the printer 4 an internal ID, XMPP login password, management page URL, management page password, and email address that correspond to the model-specific ID and serial number of the printer 4, while also consulting registration information on other printers already registered in the DB server 106. Allocating the internal ID on the basis of the model-specific ID and serial number of the printer 4 makes it possible to reliably allocate to the printer 4 a different internal ID for every individual printer, even in a case where the serial number was assigned to the printer in a different system for every model. The management page is a web page for using HTTP to compile these items of information, which are stored in the DB server 106.

The account management AP server 107 stores the XMPP login password, the management page URL, the management page password, and the email address in the DB server 106 as registration information of the printer 4, in association with the internal ID corresponding to the model-specific ID and serial number of the printer 4.

The account management AP server 107 registers in the SMTP server 101 the email address allocated to the printer 4. Registering in the SMTP server 101 the email address allocated to the printer 4 makes it possible for the email processing system 1 to receive an email, serving as a print request, that has the printer 4 as the output device.

The account management AP server 107 associates together the XMPP login password and the internal ID allocated to the printer 4, and registers same in the XMPP server 104. An XMPP JID for the XMPP server 101 to communicate with the printer 4 by using XMPP is “internal ID” @ “an XMPP domain name of the XMPP server 104”. Registering the XMPP login password and the internal ID of the printer 4 as XMPP connection information in the XMPP server 104 makes it possible for the printer 4 and the email processing system 1 to communicate with each other by using XMPP.

Having registered the printer 4 in the email processing system 1 as a output device of the print system, the account management AP server 107 sends registration result information for the printer 4 to the printer 4, which is the transmission origin of the registration request, over the HTTP server 108 (S110). The registration result information includes the internal ID, XMPP login password, management page URL, management page password, email address, and XMPP server 104 domain name allocated to the printer 4, as well as the outcome (success/failure) of the receipt of the registration request. In a case where a plurality of XMPP servers are provided to the email processing system 1 for the purpose of load sharing, then the printer 4 must be notified of the domain name of the XMPP server allocated to the printer 4, but in a case where all printers registered in the email processing system 1 communicate by a shared XMPP server, then the printer 4 need not necessarily be notified of the domain name of the XMPP server.

Having acquired the registration result information from the HTTP server 108, the printer 4 stores in the non-volatile memory the internal ID, the XMPP login password, the management page URL, the management page password, the email address, and the XMPP server 104 domain name allocated to the printer 4, generates an XMPP JID from the internal ID and the XMPP domain name, and sends the XMPP JID and the XMPP login password to the XMPP server 104 as XMPP connection information (S112).

Having acquired the XMPP JID and the XMPP login password from the printer 4, the XMPP server 104 establishes an XMPP connection with the printer 4 and sends to the printer 4 the XMPP connection result (success/failure) (S114). When the XMPP connection is successful at this time, the XMPP connection between the printer 4 and the XMPP server 104 is sustained until the power source of the printer 4 is shut off.

When an XMPP connection with the email processing system 1 is established, the printer 4 sends printer information to the HTTP server 108 (S116). The printer information includes the internal ID allocated to the printer 4, the communication specifications version, menu type information (region information) on the printer, submenu type information (region information) on the printer, and language information on the printer, and is sent by using HTTP to the URL of the HTTP server 108 corresponding to the printer information.

When the printer information is received by the HTTP server 108 from the printer 4, the content management AP server 107 stores the printer information in the DB server 106 in association with the internal ID, and also sends the receipt result (success/failure) to the printer 4 that is the transmission origin (S118). The printer information of the printer 4 is stored in the DB server 106 until the XMPP connection with the printer 4 is ended.

Having received the receipt result (success) of the printer information, the printer 4 sends to the HTTP server 108 a registration result notification job creation request (S122). A registration result notification job is a print job for printing at the printer 4 the content of registering the printer 4 in the email processing system 1. More specifically, the internal ID is sent to the URL of the HTTP server 108 associated with the registration result notification job creation request, as the registration result notification job creation request.

Having received the registration result notification job creation request, the HTTP server 108 sends the receipt result (success/failure) to the printer 4 that is the transmission origin (S124).

When the receipt result (success) of the registration result notification job creation request is sent from the HTTP server 108, the email processing system 1 generates a registration result notification job for the printer 4 to print a registration report (S126). The following is a more specific description. First, the content management AP server 107 acquires the internal ID of the printer 4 from the registration result notification job creation request; acquires from the DB server 106 information of which the user of the manager terminal 3 should be notified, such as the management page URL, the management page password, and the email address stored in association with the acquired internal ID, as well as the model-specific ID of the printer 4 stored in association with the internal ID; and delivers same to the printer communication AP server 105. Next, the printer communication AP server 105 requests in association with a job ID and model ID that the data conversion service AP server 102 generate print data for printing the information of which the user of the manager terminal 3 should be notified, as the registration report. Having received the request, the data conversion service AP server 102 causes the data conversion server 103 to generate print data corresponding to the model-specific ID. Next, the printer communication AP server 105 acquires the print data from the data conversion server 103 and stores same in the DB server 106 as a print job of the printer 4, in association with the internal ID and the job ID.

Having generated the registration result notification job, the email processing system 1 uses XMPP to provide notification of the generation of a new print job to the printer 4, which is the transmission origin of the registration request (S128). More specifically, the printer communication AP server 105 provides, to the printer 4 over the XMPP server 104, print queue information indicative of the fact that a new print job of the printer 4 has occurred. At this time, the XMPP server 104 identifies an XMPP communication partner for the printer 4, on the basis of the internal ID acquired from the printer communication AP server 105, and sends the print queue information to the printer 4 by using XMPP.

Having acquired the print queue information, the printer 4 sends the receipt result (success/failure) to the XMPP server 104 by using XMPP (S138).

Next, the printer 4 sends a request to the email processing system 1 for print job information needed to acquire the print data (S140). More specifically, the printer 4 uses HTTP to send the internal ID of the printer 4 to the URL of the HTTP server 108 corresponding to the request for print job information.

Having received the request for print job information, the email processing system 1 sends to the printer 4 the receipt result (success/failure), the job ID, the URL of the HTTP server 108 corresponding to the job ID, and the type of page-description language of the print data, as the print job information (S142). More specifically, the content management AP server 107 acquires the internal ID acquired by the HTTP server 108 as the request for print job information, and acquires from the DB server 106 the job ID and print data stored in association with the internal ID as well as the page-description language of the print data, and delivers same to the HTTP server 108. The HTTP server 108 generates a URL for accepting an acquisition request for print data corresponding to the job ID, and sends the receipt result (success/failure), the job ID, the URL for accepting the acquisition request for print data, and the type of page-description language for the print data to the printer 4 as the print job information, by using HTTP.

Having acquired the print job information, the printer 4 waits for the printer 4 to reach an idle state and, upon reaching an idle state, requests print data (S146). More specifically, the printer sends the internal ID of the printer 4 over HTTP as an acquisition request for print data to the URL of the HTTP server 108 for accepting the acquisition request for the print data.

Having received the request for print data, the email processing system 1 uses HTTP to send to the printer 4 the receipt result (success/failure) as well as the requested print data (S148). More specifically, the HTTP server 108 uses HTTP to send to the printer 4 the receipt result as well as the print data corresponding to the URL at which the request for print data was accepted.

Having acquired the print data, the printer 4 executes printing of the registration report on the basis of the print data (S150).

Having ended printing, the printer 4 sends execution result information to the HTTP server 108 (S154). More specifically, the printer 4 sends to the URL corresponding to the execution result information of the HTTP server 108 the internal ID of the printer 4, the job ID by which printing was executed, the execution result of the print job (success/failure), and the reason for which the execution result happened (normal, paper jam, out of ink, or the like) (S152).

Having acquired the execution result information at the HTTP server 108, the email processing system 1 updates the print job on the basis of the execution result information (S156). More specifically, the HTTP server 108 sends the receipt result of the execution result information (success/failure) to the printer 4, and the content management AP server 107 deletes the print data corresponding to the job ID from the DB server 106 on the basis of the execution result information received by the HTTP server 108.

During the execution of the setup sequence described above, the manager terminal 3, having sent the setup start request, periodically requests the setup status from the printer 4 (S130). More specifically, a request for the status of setup is sent to the URL of the printer 4 corresponding to the request for the setup status.

Having accepted the request for the setup status, the printer 4 sends registration status information to the manager terminal 3 by using HTTP (S132). The registration status information is the same as the content sent to the manager terminal 3 in S102 by the printer 4 immediately after the setup start request was acquired.

Having received the registration status information, the manager terminal 3 produces a screen display of the registration status on the basis of the received registration status information, similarly with respect to S104 (S134). At the stage where registration of the printer 4 in the email processing system 1 is completed, for example, the management page URL, the management page password, the email address, and the like are displayed on a screen of the manager terminal 3.

### 2-2. Login Sequence

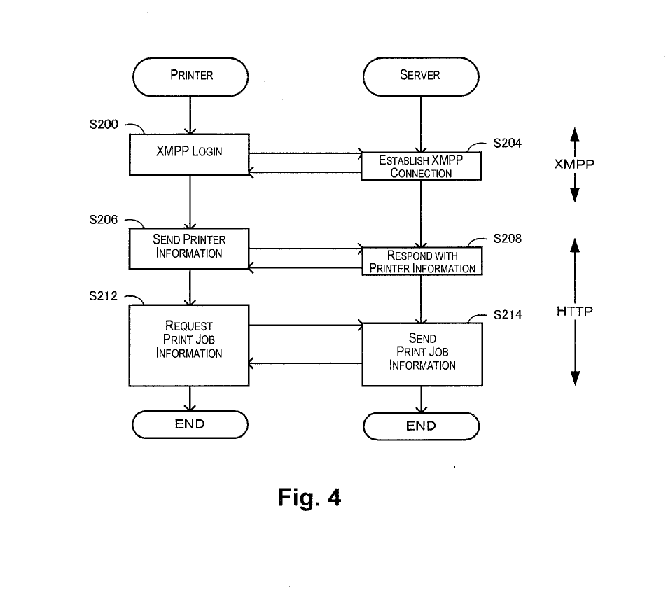

FIG. 4 is a diagram illustrating the login sequence. The login sequence starts when the user, having pressed on a power source button of the printer 4 to shut off the power source after the end of the setup sequence, later presses on the power source button again to turn on the power source. In the login sequence, the printer 4 carries out a process for initializing each of the parts, and also establishes an XMPP connection with the email processing system 1 and carries out a check of the print job.

More specifically, similarly with respect to S112 of the setup sequence, the printer 4 sends the XMPP connection information to the XMPP server 104 (S200). Having acquired the XMPP connection information, the XMPP server 104 establishes an XMPP connection, similarly with respect to S114 (S202).

Having established an XMPP connection with the email processing system 1, the printer 4 uses HTTP to send the printer information to the email processing system 1, similarly with respect to S116 of the setup sequence (S206). That is, the transmission of the printer information is implemented every time the XMPP connection is established with the email processing system 1. Having acquired the printer information, the server uses HTTP to send the receipt result to the printer 4, similarly with respect to S118, and also stores the printer information until the end of the XMPP connection (S208).

Having sent the printer information to the email processing system 1, the printer 4 uses HTTP to send a request for the print job information to the email processing system 1, similarly with respect to S140 of the setup sequence (S212). Having acquired the request for the print job information, the email processing system 1 uses HTTP to send the print job information to the printer 4, similarly with respect to S142 (S214). Having acquired the print job information, the printer 4 requests the print data and executes printing when there is a print job. This manner by which the printer 4 automatically acquires the print job information after the power has been turned on makes it possible, immediately after the power has been turned on, for the printer 4 to execute a print job generated in the email processing system 1 while the power was shut off.

### 2-3. Print Sequence

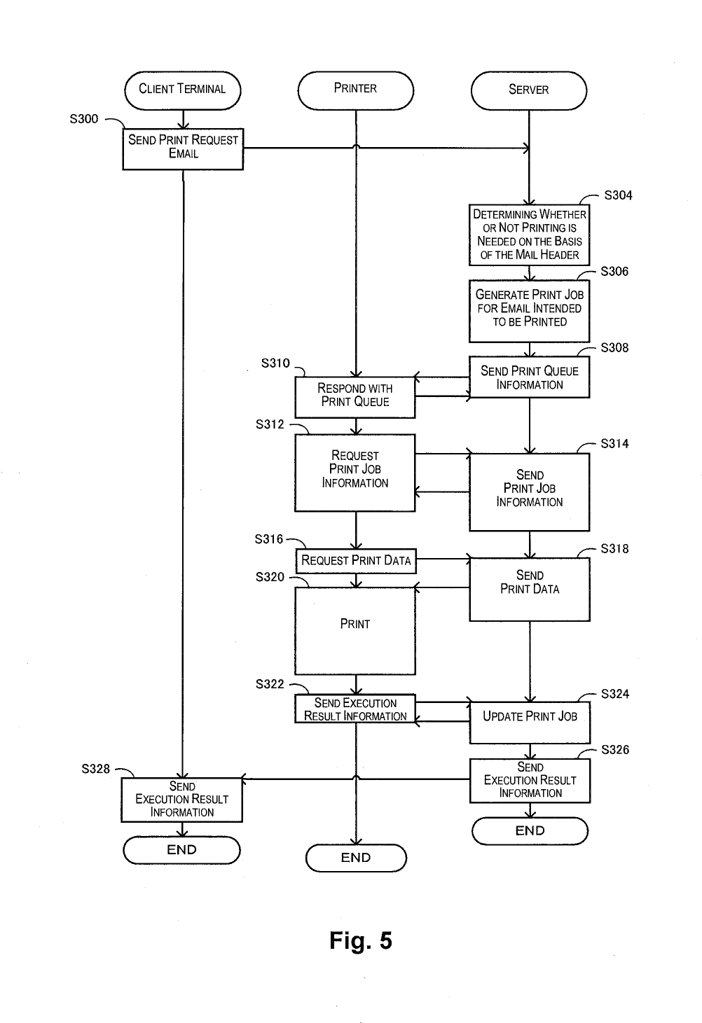

FIG. 5 is a drawing illustrating the print sequence. The print sequence is started by the transmission of an email from the manager terminal 3 or the guest terminal 2 to an email address destination allocated to a registered printer (S300). The email processing system 1, as shall be described below, processes the body and attached file(s) of the received email as being intended to be printed. A destination email address of a print request, which is different for every printer, is either displayed on the screen of the manager terminal 3 or printed by printer 4 during the setup sequence, as has already been described. As such, a managing user who has used the manager terminal 3 to register the printer 4 in the email processing system 1 and a guest user who has been provided with notification of the email address by the managing user are both able to use any terminal that is connected to the Internet to send the print request for the printer 4 to the email processing system 1. The following describes when an email serving as a print request is sent from the guest terminal 2 to the email address corresponding to the printer 4.

Upon receiving the email, the email processing system 1 analyzes the header of the email, and determines whether the received email is an email intended to be printed or is a specific email not intended to be printed (S304). That is, the question of whether or not printing is needed is determined on the basis of the mail header. More specifically, when the STMP server 101 receives the email of the registered email address destination, the data conversion service AP server 102 acquires a “TO” and a “CC”, serving as transmission destination information, from the mail header. The “TO” and the “CC” are listed together with a “BCC” (blind carbon copy) in the header of the email by a mail user agent (MUA) generating the email.

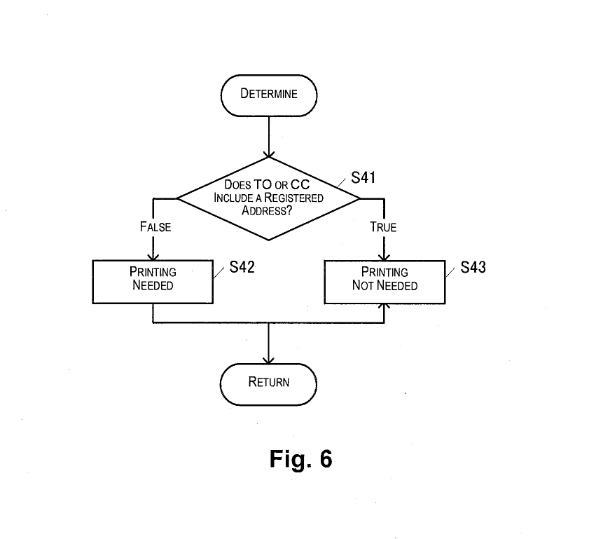

As illustrated in FIG. 6, the data conversion service AP server 102 determines whether an email address allocated to a registered printer is included in either the “TO” or the “CC” acquired from the header of the email (S41); in a case where no such email address is included, the email is regarded as intended to be printed (S42), and in a case where such an email address is included, the email is discarded as a specific email not intended to be printed. In a case where an email is received by the SMTP server 101 at an email address allocated to a registered printer, despite an email address allocated to a registered printer not being included in both the “TO” and the “CC”, that email is one where an email address allocated to a registered printer is set to “BCC” during sending. As such, in a case where an email address allocated to a registered printer is set to BCC and an email is sent, that email is processed as being intended to be printed. However, in a case where an address other than an email address allocated to a registered printer is set for either the “TO” or “CC” and the email was sent, that email is discarded without being regarded as intended to be printed.

Next, the email processing system 1 generates a print job on the basis of the email determined to be intended to be printed (S306). First, the printer communication AP server 105 understands the body and attached files of the email to be intended to be printed, and allocates an internal ID and job ID to every file. The internal ID is identified from the email address. Next, the printer communication AP server 105 delivers what is intended to be printed to the data conversion server 103, together with the internal ID and job ID, and print data corresponding to the model and print settings is generated on the basis of what is intended to be printed. The printer communication AP server 105 then stores the print data in the DB server 106 as a print job of the printer 4, by association with the job ID and the internal ID of the printer 4.

Next, the email processing system 1 uses XMPP to send the print queue information to the guest terminal, which is the request origin for the print execution request (S308). More specifically, the printer communication AP server 105 uses XMPP to provide notification of the print queue information to the printer 4, similarly with respect to S128 of the setup sequence. The email processing system 1 is thus able to autonomously execute the process from when the print request is received until when the print queue information is sent to the printer 4, in order to use XMPP to send the print queue information, and there is no need to poll the printer 4. For this reason, notification of the generation of a print job can be provided immediately to the printer 4, and notification of the generation of print data can be provided to the printer 4 with a minimal amount of communication.

Having acquired the print queue information, the printer 4 uses XMPP to send to the XMPP server 104 the receipt result (success/failure), similarly with respect to S138 of the setup sequence (S310).

Next, similarly with respect to S140, the printer 4 uses HTTP to send a request to the email processing system 1 for print job information needed to acquire the print data (S312). More specifically, the printer 4 uses HTTP to send the internal ID of the printer 4 to the URL of the HTTP server 108 corresponding to the request for print job information.

Having received the request for the print job information, the email processing system 1 uses HTTP to send to the printer 4 the receipt result (success/failure), the job ID, the URL of the HTTP server 108 corresponding to the job ID, and the type of page-description language for the print job as the print job information, similarly with respect to S142 (S314).

Having acquired the print job information, the printer 4 waits for the printer 4 to reach an idle state, similarly with respect to S146, and when an idle state is reached, requests that print data be sent by sending to the HTTP server 108 a URL for accepting a request to acquire print data (S316).

Having been requested to send the print job, the HTTP server 108 uses HTTP to send to the printer 4 the print data that corresponds to the URL at which the request to acquire the print data was accepted, along with the receipt result (success/failure), similarly with respect to S148 (S318).

Having acquired the print data, the printer 4 executes printing on the basis of the print data, similarly with respect to S150 (S320).

Having finished printing, the printer 4 sends execution result information on the print job to the HTTP server 108, similarly with respect to S154 (S322).

Having acquired the execution result information at the HTTP server 108, the email processing system 1 updates the print job on the basis of the execution result information, similarly with respect to S156 (S324).

Next, the email processing system 1 sends by email the execution result for the print request (success/failure) to the guest terminal 2, which is the transmission origin for the print request (S326). More specifically, the content management AP server 107 generates on the basis of the execution result information an email where the body is text indicative of the completion or failure of printing as well as of what was intended to be printed for which printing either completed or failed, and where the destination is the guest terminal 2, which is the transmission origin of the print request, and sends the generated email to the guest terminal 2 via the SMTP server 11.

When the guest terminal 2 receives the email (S328), the user of the guest terminal 2 is able to know the result of processing for the print request.

Of emails sent to an email address destination allocated to a printer registered in the email processing system, the email processing system 1 described above understands as being intended to be printed only those emails for which the email address allocated to the printer registered in the email processing system is set to BCC only.

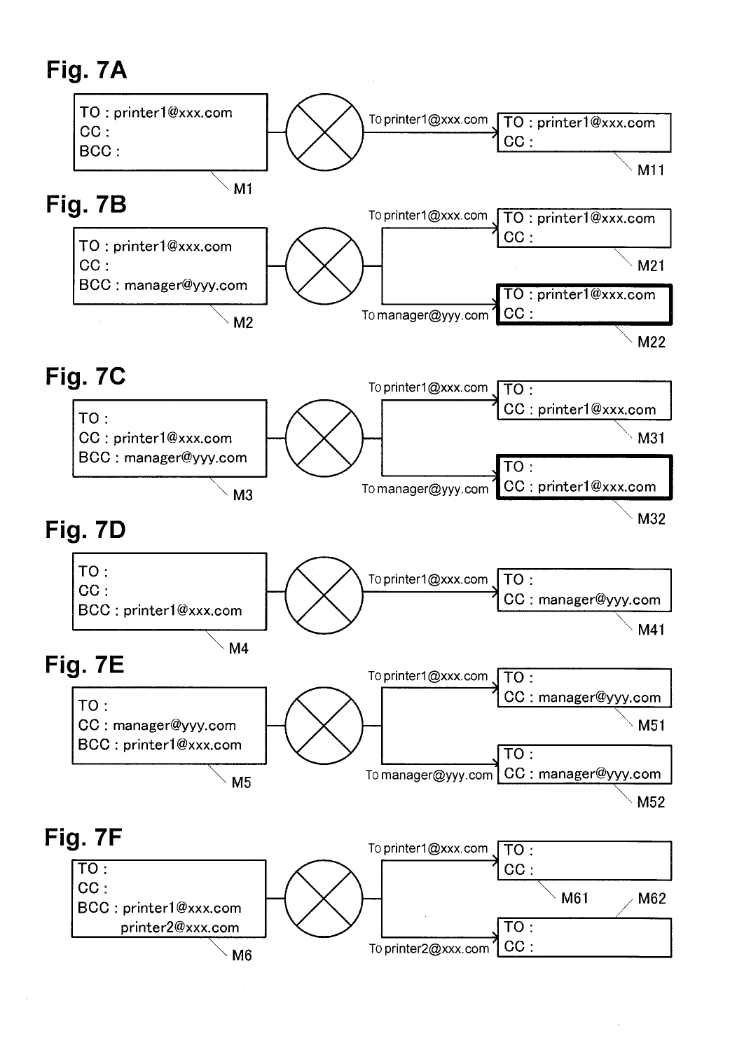

Described herein is the relationship between the transmission destination of an email sent from any terminal and the email received by the email processing system 1, with reference to FIGS. 7A-7F. In FIGS. 7A-7F, an email address corresponding to the printer 4 registered in the email processing system 1 is denoted by “printer1@xxx.com”. This address is hereinafter understood to be a registered printer address. An email M1 for which only a registered printer address is set for the “TO” as the transmission destination, as illustrated in FIG. 7A, is distributed only to the email processing system 1. The email M11 distributed to the email processing system 1 is not intended to be printed, because the “TO” of the mail header includes a registered printer address. This is because the following problems arise in a case where an email M2 for which a registered printer address has been set for the “TO” and the separate email address “manager@yyy.com” has been set for the “BCC” as the transmission destinations is distributed, as illustrated in FIG. 7B.

Now, in a situation where a user Y of an email address “manager@yyy.com” prepares for an absence by activating an automatic response function of a mail transfer agent (MTA), a user X of the guest terminal 2 will send the email M2 in an attempt to cause the printer 4 to execute printing. When the email M2 is sent, the email M2 is distributed to the email processing system 1, and an email M22 is distributed to the MTA corresponding to the email address “manager@yyy.com”. In so doing, the MTA corresponding to the email address “manager@yyy.com” generates and sends an email where the email addresses included in the “TO” and the “CC” of the header of the email M22 are the transmission destinations, because the automatic response function has been set to active. As a result, the email processing system 1 will receive not only the email M21 but also an email sent in reply to the email M22. Because a registered printer address was set for the “TO” of the header of the email automatically sent in reply to the email M22, should an email where the “TO” of the mail header includes a registered printer address be hypothetically understood as being intended to be printed, both the email M21 and the email sent in automatic reply to the email M22 would be printed, and wasteful printing would be executed. This problem similarly occurs in a case where an email where a registered printer address has been set for the “CC” is understood as being intended to be printed, as illustrated in FIG. 7C. Such unintended and wasteful printing can also occur in a case where automatic forwarding by an MTA has been activated.

In the embodiment described above, a case where emails M4, M5 where a transmission destination has not been set for the “TO” and for the “CC” and where a registered printer address has been set for the “BCC” are sent, as illustrated in FIGS. 7D and 7E, is the only case where the corresponding emails M41, M51 received by the email processing system 1 are processed as being intended to be printed.

When a transmission destination has not been set for the “TO” and the “CC” and when the “BCC” includes a registered printer address, as illustrated in FIGS. 7D and 7E, then even in a case where an email M6 where the “BCC” also includes another email address “printer2@xxx.com”, the corresponding email M61 received by the email processing system 1 is still understood to be intended to be printed. When herein the other email address “printer2@xxx.com” set for the “BCC” of the email M6 is allocated to the printer 5, which has been registered in the email processing system 1 separately from the printer 4 corresponding to “printer1@xxx.com”, then the user of the guest terminal 2 can cause the printer 5 and a printer 6 to each print the body and attached files of the email M6 by sending one email M6. Further, even when the automatic response function has been set to active for the other email address “printer2@xxx.com” set for the “BCC” of the email M6, because the registered printer address “printer1@xxx.com” cannot be acquired from the mail header of an email M62 distributed to the other email address “printer2@xxx.com”, printing that is based on an email sent in automatic response to the email M62 will not be executed at the printer 4 corresponding to “printer1@xxx.com”. Thus, the email processing system 1 described above is able to prevent the execution of wasteful data processing, such as printing that is based on an automatically replied email or the like, but also enables multi-address transmission of an email to be printed at a plurality of printers.

### 3. Other Embodiments

The technical scope of the invention is in no way limited to the embodiment described above; rather, it will be readily understood that a variety of modifications can be added in a scope that does not depart from the spirit of the invention. For example, a user setting for the printer 4 regarding an attribute of a specific email not intended to be printed may be accepted, the question of whether or not printing is required then being determined on the basis of this setting. More specifically, a setting for the intention to be printed may be accepted for an email where the “TO” or the “CC” includes a registered printer address and yet the “TO” or the “CC” does not include another email address.

The embodiment described above illustrated an example where the printer 4 automatically executes the print job upon receiving the print queue information from the email processing system 1, but, for example, the user I/F 46 of the printer 4 having received the print queue information may display information indicative of the presence of the print job, the printer 4 then waiting for a user command to execute the print job before executing the print job.

The embodiment above describes an example where the email processing system 1 is constituted of a plurality of physically independent server computers, but it would also be possible for the functions of the email processing system 1 to implemented with a single server computer. The format of communication is also not limited to being the one described above, but rather another format of communication may be used. For example, instead of XMPP, another push-type communication such as Web Socket may be used.

What is claimed is:

1. An email processing system, comprising:
a communication unit for receiving an email sent to a pre-established first address;
a determination unit for determining whether or not the received email is a specific email where the transmission destination includes a second address other than the first address and where a response by email can be sent to the first address from the second address; and
a processing unit for executing a predetermined data process based on an email determined not to be the specific email but not executing the predetermined data process based on an email determined to be the specific email.

2. The email processing system as set forth in claim 1, wherein
the determination unit determines not to be the specific email an email where both the “TO” and the “CC” of a mail header do not include the first address.

3. The email processing system as set forth in claim 1, wherein
the determination unit determines not to be the specific email an email including only the first address as the transmission destination.

4. The email processing system as set forth in claim 1, wherein
the predetermined data process is a process for generating print data on the basis of an email determined not to be the specific email and sending the print data to a printer associated with the first address.

5. An email processing method, comprising:
receiving an email sent to a pre-established first address;
determining whether or not the received email is a specific email where the transmission destination includes a second address other than the first address and where a response by email can be sent to the first address from the second address; and
executing a predetermined data process based on an email determined not to be the specific email but not executing the predetermined data process based on an email determined to be the specific email.
